(19) United States
(12) Patent Application Publication
(10) Pub. No.: US 2014/0087658 A1
(43) Pub. Date: Mar. 27, 2014

(54) COMMUNICATION DEVICE

(71) Applicant: FOCALTECH SYSTEMS, LTD., Grand Cayman (KY)

(72) Inventors: Weijing HOU, Shenzhen (CN); Lianghua MO, Shenzhen (CN); Wenjun ZHANG, Shenzhen (CN); Huaiyi XU, Shenzhen (CN)

(73) Assignee: FocalTech Systems, Ltd., Grand Cayman (KY)

(21) Appl. No.: 13/728,356

(22) Filed: Dec. 27, 2012

(30) Foreign Application Priority Data
Sep. 21, 2012 (CN) 201210357099.1

(51) Int. Cl. H04M 1/02; H04B 5/02

(52) U.S. Cl. CPC H04M 1/0266; H04B 5/02
USPC 455/41.1; 455/566

(57) ABSTRACT

A communication device applied in the field of electronic device technique is disclosed. In the communication device of embodiments of the invention, when a new communication function is added, the communication antenna may be arranged on the surface of the touch-display screen of the communication device or is embedded inside the touch-display screen; or an electrode included in the touch-display screen of the communication device is reused as the communication antenna and the communication function and the electrode function is coordinated by a control circuit; furthermore, a communication processing function circuit corresponding to the communication antenna is configured flexibly in conjunction with other processors of the communication device. Therefore the volume of the communication device is not increased when a new communication function is added to the communication device.

The present application claims the priority of Chinese Patent Application No. 201210357099.1, titled “COMMUNICATION DEVICE”, filed with the Chinese State Intellectual Property Office on Sep. 21, 2012, the entire disclosure of which are incorporated herein by reference.

### FIELD OF THE INVENTION

The present invention relates to the technique field of electronic device, and in particular to a communication device.

### BACKGROUND OF THE INVENTION

Currently, display and touch screens have become standard configuration of communication terminals (for example, a mobile phone) and consumer electronics (for example, a Personal Digital Assistant). In addition, with the development of the communication technique, these display and touch screen devices have multiple communication functions, such as a wireless charging function, a Near Field Communication (NFC) function, a Wireless-Fidelity (Wi-Fi) communication function and a Radio Frequency Identification (RFID) function.

In the display and touch screen devices of the prior art, each communication function is achieved by a separate module, and each communication function module includes an antenna and a corresponding function circuit. Therefore, as the communication functions increase, volume and cost of the display and touch screen device increase.

### SUMMARY OF THE INVENTION

An embodiment of the present invention provides a communication device, where the volume of the device with the communication function is not increased when a new communication function is added.

An embodiment of the present invention provides a communication device, including: a touch-display screen, a communication antenna and a communication processing function circuit,

the communication antenna is arranged on a surface of the touch-display screen or is embedded inside the touch-display screen; the communication antenna is connected with the communication processing function circuit, and

the communication processing function circuit is adapted to control the communication antenna to make it perform a communication function, and perform a corresponding process on a signal received and/or transmitted by the communication antenna.

An embodiment of the present invention provides a communication device, including: a touch-display screen, a communication antenna, a control circuit, a touch-display screen processing function circuit and a communication processing function circuit,

an electrode included in the touch-display screen is reused as the communication antenna, and the communication antenna is connected with the touch-display screen processing function circuit and the communication processing function circuit via the control circuit,

where the control circuit is adapted to control the communication antenna to make it perform a communication function corresponding to the communication antenna during an idle state of performing an electrode function, and the communication processing function circuit is adapted to perform a corresponding process on a signal received and/or transmitted by the communication antenna when the communication antenna performs the communication function.

In the communication devices according to the embodiments of the present invention, if a new communication function is added, the communication antenna may be arranged on the surface of the touch-display screen of the communication device or be embedded inside the touch-display screen, or the electrode included in the touch-display screen of the communication device is reused as the communication antenna, with the communication function and the electrode function being coordinated by the control circuit of the communication processing function circuit; the communication processing function circuit corresponding to the communication antenna is configured flexibly in conjunction with other processors of the communication device. This takes full advantage of the space of existing component parts of the communication device and a separate module does not need to be added into the communication device to achieve the communication function, so that the volume of the communication device is not increased when the new communication function is added to the communication device.

### BRIEF DESCRIPTION OF THE DRAWINGS

In order to illustrate technical solutions of embodiments of the present invention or the prior art more clearly, drawings used in the description of the embodiments or the prior art are described briefly hereinafter, and obviously, the drawings in the following description are only some embodiments of the present invention, and those skilled in the art can obtain other drawings according to these drawings without any creative work.

FIG. 1 is a schematic diagram of a logic structure of a communication device according to an embodiment of the present invention;

FIG. 2a is a partial schematic diagram of an arrangement of a communication antenna in a touch-display screen in a communication device according to an embodiment of the present invention;

FIG. 2b is a partial schematic diagram of another arrangement of a communication antenna in a touch-display screen in a communication device according to an embodiment of the present invention;

FIG. 2c is a schematic diagram of another arrangement of a communication antenna in a touch-display screen in a communication device according to an embodiment of the present invention;

FIG. 2d is a partial schematic diagram of another arrangement of a communication antenna in a touch-display screen in a communication device according to an embodiment of the present invention;

FIG. 3a is a schematic diagram of a stack structure of a touch-display screen in a communication device according to an embodiment of the present invention;

FIG. 3b is a schematic diagram of another stack structure of a touch-display screen in a communication device according to an embodiment of the present invention;

FIG. 4 is a schematic diagram of a logic structure of another communication device according to an embodiment of the present invention;

FIG. 5a is a schematic diagram illustrating that an electrode in a touch-display screen is reused as a communication antenna in a communication device according to an embodiment of the present invention;

FIG. 5b is another schematic diagram illustrating that an electrode in a touch-display screen is reused as a communication antenna in a communication device according to an embodiment of the present invention;

FIG. 6 is a schematic structural diagram of a processor in a communication device according to an embodiment of the present invention; and

FIG. 7 is a schematic diagram of a logic structure of a communication device in a specific application example.

### DETAILED DESCRIPTION

The technical solutions of the embodiments of the present invention will be described clearly and completely hereinafter in conjunction with the drawings of the embodiments of the present invention, and obviously, the described embodiments are only part but not all of embodiments of the present invention. All other embodiments that are obtained by those skilled in the art based on the embodiments in the present invention without any creative work are within the protection scope of the present invention.

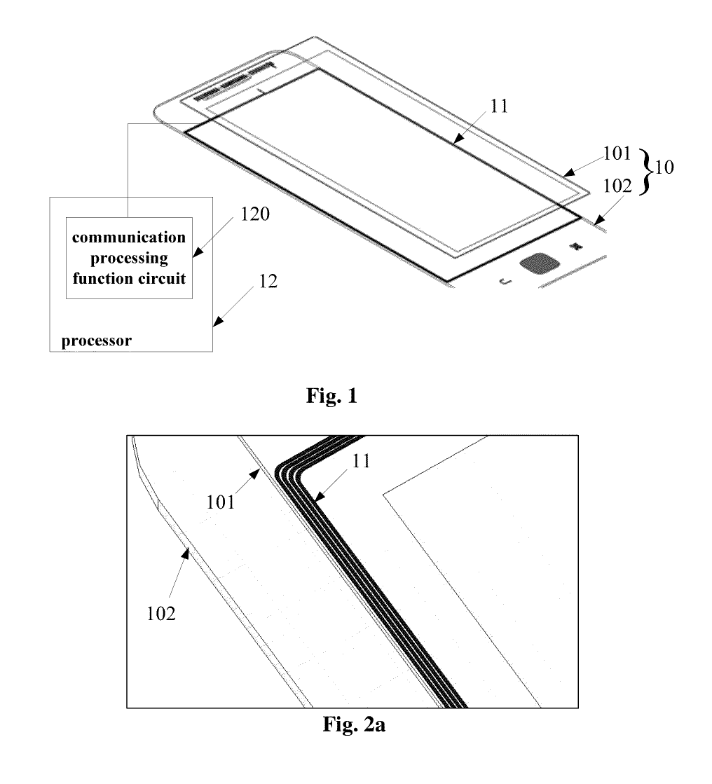

An embodiment of the present invention provides a communication device, which may be a device such as a mobile phone, a Global Positioning System (GPS) device or a personal digital assistant device. The schematic diagram of the logic structure of the communication device is showed in FIG. 1, which includes:

a touch-display screen 10, a communication antenna 11 and a communication processing function circuit 120, where the communication antenna 11 is arranged on the surface of the touch-display screen 10 or is embedded inside the touch-display screen 10, the communication antenna 11 is connected with the communication processing function circuit 120, where the communication processing function circuit 120 is adapted to control the communication antenna 11 to make it perform a communication function, and perform a corresponding process on a signal which is received and/or transmitted by the communication antenna.

It is to be understood that, the touch-display screen 10 may be a capacitive touch-display screen which mainly has functions such as displaying and touching, the surface of the touch-display screen 10 includes an outer surface of the communication device that can be seen by the user and an inner surface of the communication device that can't be seen by the user. Specifically, during the arrangement of the communication antenna 11, the communication antenna may be arranged at a free position of the surface of the touch-display screen 10, i.e. a position of the surface of the touch-display screen 10 where no component or metal wire is arranged, and furthermore, the free position should not be a place that can be seen by the user through the outer surface of the communication device, for example, in FIG. 1, the communication antenna 11 is arranged in an invisible region of the periphery of the touch-display screen 10, i.e. a region that can't be seen by the user through the outer surface of the communication device. If the communication antenna 11 is arranged on the outer surface of the touch-display screen 10, the communication antenna 11 may be covered by ink or the like, to protect the communication antenna 11 and beautify the appearance of the communication device.

In the arrangement of the communication antenna 11 in the touch-display screen 10, techniques such as nano-silver or nano-copper may be adopted.

The communication antenna 11 may be any one of the following antennas: a GPS communication antenna, a wireless charging antenna, an NFC antenna, an RFID antenna, a Bluetooth communication antenna, a Wi-Fi communication antenna, a Frequency Modulation (FM) broadcast antenna, a television (TV) broadcast antenna and so on, and may also be a near field antenna or a far field antenna, where the near field antenna is a communication antenna whose radio frequency band is in a range from the long wave to the short wave, generally operates at a frequency ranges from 100 kHz to 30 MHz, and has a short communication distance (for example shorter than 10 cm); the far field antenna generally operates at the high frequency band, and has a long communication distance (for example longer than 10 cm).

The communication processing function circuit 120 may perform a control to enable or disable the communication function corresponding to the communication antenna 11 (the function of receiving and/or transmitting signals), control the clock of the communication function, and so on; and the communication processing function circuit 120 processes the received and/or transmitted signal differently as the type of the communication antenna 11 is different, which may include processing the signal, which is received and/or transmitted by the communication antenna 11, by using a communication protocol corresponding to the communication antenna 11, and performing functions such as storing and transferring of data, and for example:

If the communication antenna 11 is a wireless charging antenna, the communication processing function circuit 120 controls the wireless charging antenna to make it transmit a signal and/or receive a signal, charges the communication device by using the signal received by the communication antenna 11 as a charging signal, and charges other devices by using the signal transmitted by the communication antenna 11. Charging the communication device by using the charging signal is achieved mainly by electromagnetic induction, and the communication processing function circuit 120 may control the wireless charging antenna according to a certain control strategy, the signal receiving function of the wireless charging antenna may be disabled and the signal transmitting function may be reserved if it is detected that a wired charger is plugged in, and in this case the communication device serves as a charging station for charging other devices, for example.

If the communication antenna 11 is an NFC antenna, the communication processing function circuit 120 may control the communication antenna 11 to make it perform an NFC communication function, pack a signal to be transmitted by the NFC antenna by using an NFC protocol and deliver the packed signal to the NFC antenna for transmitting, or after the NFC antenna receives a signal, the communication processing function circuit 120 may unpack the received signal by using the NFC protocol and then perform some processes. Further, the communication processing function circuit 120 may operate in an active mode or in a passive mode. In the active mode, the communication processing function circuit 120 initiates a communication with other devices by the NFC antenna actively, and in the passive mode, the communication processing function circuit 120 detects a signal transmitted from other devices and received by the NFC antenna passively. The NFC protocol may include but not limit to various near field non-contact communication technical protocols such as ISO/IEC18092, ISO14443, MIFARE and Felica.

If the communication antenna 11 is an RFID communication antenna, the communication processing function circuit 120 controls the communication antenna 11 to make it perform an RFID communication function, and may also set the RFID communication antenna to use it as a signal reader and/or a signal tag, where the RFID communication antenna receives a signal from other RFID communication devices when being used as the signal reader, and the RFID communication antenna transmits a signal to other RFID communication devices when being used as the signal tag.

It should be noted that, the communication processing function circuit 120 described above may be integrated into a separate chip which is newly added into the communication device; or may be integrated into one or more existing processors 12 (for example, a touch screen controller, a display controller such as an LCD controller, or a system processor) of the communication device; or some functions of the communication processing function circuit 120 are integrated into one or more existing processors (for example, a touch screen controller or an LCD controller) of the communication device and other functions are integrated into a separate and newly added processor. FIG. 1 shows one specific implementation in which the communication processing function circuit 120 is integrated into a processor 12 of the communication device. Since the connection between the touch-display screen 10 and a touch screen or an LCD processor used to control the touch-display screen 10 in the communication device is relatively easy to be implemented, the communication processing function circuit 120 may be integrated into the touch screen or the LCD processor, to save connection wires between the communication processing function circuit 120 and the touch-display screen 10; and since the processing function of the system processor in the communication device that is used to process various application programs is strong and stable, the communication processing function circuit 120 may be integrated into the system processor in consideration of performance requirements; so it can be seen that, the communication processing function circuit 120 may be integrated flexibly into the existing processors in the communication device according to the user's demand, which significantly decreases the volume of the communication device.

It can be seen that, in the communication device of the embodiment of the invention, if a new communication function is added, the communication antenna 11 may be arranged on the surface of the touch-display screen 10 of the communication device or is embedded inside the touch-display screen 10, and the communication processing function circuit 120 corresponding to the communication antenna 11 may be configured flexibly in conjunction with other processors of the communication device, this takes full advantage of the space of the existing component parts in the communication device and a separate module does not need to be added into the communication device to achieve the communication function, so that the volume of the communication device is not increased when the new communication function is added to the communication device.

In a specific embodiment, in order to achieve the near field communication function, energy and data exchange is generally implemented in an electromagnetic coupling manner since the communication distance is short, and the communication antenna 11 in the above communication device may be implemented by using a single-circle annular coil or a multi-circle annular coil, where the annular coil may have any possible shape, such as rectangle, ellipse or racetrack shape; in order to achieve the far field communication function, an electric conductor having a special shape is required to be used as the communication antenna 11 since the communication distance is long and the frequency is high, specifically, a folded monopole antenna may be used as the communication antenna 11.

Specifically, the touch-display screen 10 in the communication device may include a touch screen body 101, a cover lens 102 and a display 103 such as a Liquid Crystal Display (LCD). The touch-display screen 10 may further include: electrodes formed by multiple conductive materials such as Indium Tin Oxide (ITO); a Flexible Printed Circuit (FPC) for connecting the touch-display screen 10 and the processor 12 of the communication device; and metal wires for connecting the electrodes and the FPC, where the connection between the communication antenna 11 and the communication processing function circuit 120 is also achieved by the FPC or achieved directly by the metal wires, and the touch screen body 101, the cover lens 102 and the display 103 included in the touch-display screen 10 may be stacked from top to bottom in the following order: the display 103, the touch screen body 101 and the cover lens 102, the “from top to bottom” described here refers to a direction that the user looks the touch-display screen 10 from the back surface (i.e. the inner surface) of the touch-display screen 10.

The arrangement of the communication antenna 11 in the communication device may include but not limit to the following ways:

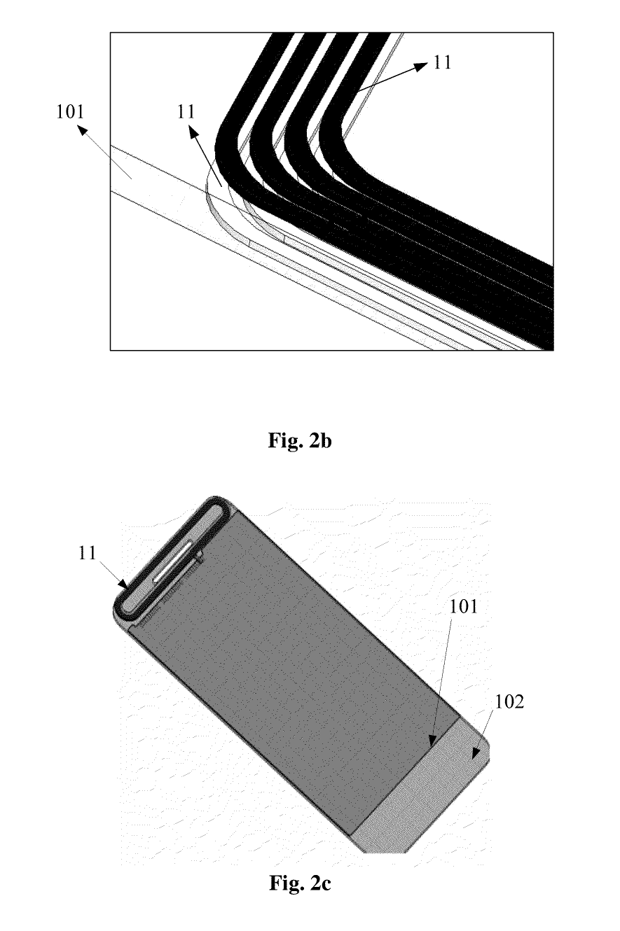

(1) Referring to FIG. 2a which is a partial schematic diagram of an arrangement of the communication antenna 11 in the touch-display screen 10, in this arrangement, a multi-circle annular coil is used as the communication antenna 11, and is arranged in a free area of an invisible region (i.e. an region that can't be seen by the user through the outer surface of the communication device) around the touch screen body 101 in the touch-display screen 10, therefore, the communication antenna 11 may be arranged on the touch screen body 101 by using the existing simple TP process directly, and the communication antenna 11 is embedded inside the touch-display screen 10 after the component parts of the touch-display screen 10 are stacked together since the touch screen body 101 is the middle layer of the touch-display screen 10.

It is to be understood that, the communication antenna 11 may be located on one surface of the touch screen body 101, for example be located on a DRIVER layer or a SENSOR layer, and the specification of the annular coil may be adjusted according to requirements, where the DRIVER layer is an electrode of a signal transmitting unit in the communication device which is used to detect the user's touch on the touch-display screen 10, and the SENSOR layer is an electrode of a signal receiving unit in the communication device which is used to detect the user's touch on the touch-display screen 10.

(2) Referring to FIG. 2b which is a partial schematic diagram of another arrangement of the communication antenna 11 in the touch-display screen 10, in this arrangement, a multi-circle annular coil is used as the communication antenna 11, and is arranged in a free area of an invisible region around the touch screen body 101 in the touch-display screen 10, the communication antenna 11 is located on two surfaces of the touch screen body 101, which can increase the inductance of the communication antenna 11 and enhance the efficiency of the low frequency band. Furthermore, the multi-circle annular coil may be arranged on the two surfaces of the touch screen body 101 in a stagger manner to increase the inductance of the communication antenna 11.

(3) Referring to FIG. 1 which is a schematic diagram of another arrangement of the communication antenna 11 in the touch-display screen, in this arrangement, a rectangular multi-circle annular coil is used as the communication antenna 11, and is arranged in a free area of an invisible region of the back surface (i.e. the inner surface) of the cover lens 102 in the touch-display screen 10, the communication antenna 11 is located on the back surface of the cover lens 102, and the process of arranging the coil on the cover lens 102 directly is mature.

(4) Referring to FIG. 2c which is a schematic diagram of another arrangement of the communication antenna 11 in the touch-display screen 10, in this arrangement, a racetrack shaped annular coil is used as the communication antenna 11, and is arranged in an area with no interference-avoiding requirement of the back surface of the cover lens 102 in the touch-display screen 10, i.e., an area that has no interference-avoiding requirement, and it is required that there is no other antenna nearby, such as an area near a receiver.

(5) Referring to FIG. 2d which is a partial schematic diagram of another arrangement of the communication antenna in the touch-display screen 10, in this arrangement, a folded monopole antenna is used as the communication antenna 11, and is arranged in a free area of the back surface of the cover lens 102 in the touch-display screen 10, such as a receiver area, thus the far field antenna is achieved. In other specific embodiments, in order to achieve the far field antenna, any one of the following antennas can be used as the communication antenna 11: a circular or elliptical polarized antenna (such as a rectangular patch antenna or a planar spiral antenna), a monopole antenna and a dipole antenna.

It can be seen that, there are multiple ways to arrange the communication antenna 11. Specifically, the communication antenna may be arranged in a free area of an invisible region of any one of the following structures: the cover lens 102, the periphery of the touch screen body 101, the display 103 and the FPC (not shown in the drawing); or the communication antenna 11 may be arranged in the area with no interference-avoiding requirement of any one of the following structures: the cover lens 102, the touch screen body 101, the display 103 and the FPC; or the communication antenna 11 is arranged inside the touch screen body 101 or the display 103. Specifically, the communication antenna 11 may be arranged on any one surface of any one of the following structures: the touch screen body 101, the cover lens 102, the display 103 and the PFC; or the communication antenna 11 may be arranged on two surfaces of any one of the following structures to increase the inductance: the touch screen body 101, the cover lens 102, the display 103 and the PFC. In addition, the communication antenna 11 described above may use silver paste which connects the electrode in the touch-display screen 10 and the FPC, or may use other metals or conductors.

Further, in order to avoid influences of the metals near the communication antenna 11 such as the LCD shielding case or the metal wires, and to decrease eddy current loss, a layer of magnetic conductive sheet 104 may be added in the touch-display screen 10 of the communication device, the magnetic conductive sheet 104 may be for example a ferrite sheet, and there are two arrangements of the magnetic conductive sheet 104 as follows:

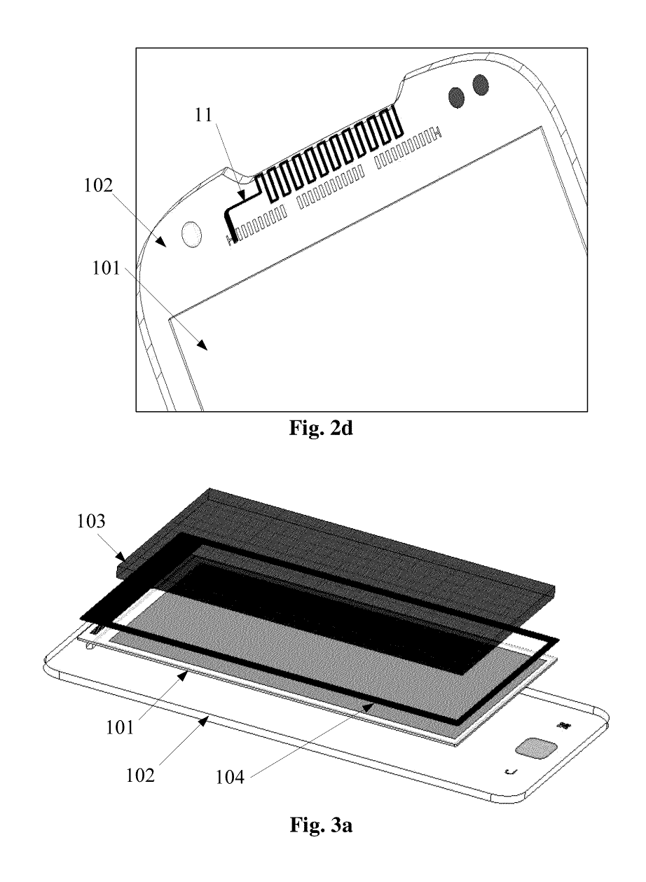

(1) Referring to FIG. 3a which is a schematic diagram of a stack structure of the touch-display screen 10, the magnetic conductive sheet 104 is affixed to the communication antenna 11, and is located between touch screen body 101 and display 103 and located at the periphery of the display 103, and the magnetic conductive sheet 104 should not cover the display 103 in order not to influence displaying of the touch-display screen 10, therefore, the touch-display screen 10 has the following stacking order from top to bottom: the display 103, the magnetic conductive sheet 104, the touch screen body 101 and the cover lens 102.

(2) Referring to FIG. 3b which is a schematic diagram of another stack structure of the touch-display screen 10, the magnetic conductive sheet 104 is affixed to the display 103, and in this case, the magnetic conductive sheet 104 does not cover the display 103 and thus does not influence displaying of the touch-display screen 10, therefore, the touch-display screen 10 has the following stacking order from top to bottom: the magnetic conductive sheet 104, the display 103, the touch screen body 101 and the cover lens 102.

Furthermore, in order to improve shielding effect, the communication antenna 11 of the communication device may be connected to a ground terminal via a switch, and the communication processing function circuit 120 is connected with a control terminal of the switch, therefore, the communication processing function circuit 120 is also adapted to control the switch to make it close when the corresponding communication function of the communication antenna 11 is in an inactive state, so that the communication antenna 11 is connected to ground.

Taking the arrangement of the communication antenna 11 showed in FIG. 2c as an example, the number of circles of the annular coil is set to 13, the material of the annular coil is silver paste, the width is 0.1 mm, the thickness is 0.05 mm, and the magnetic conductivity u of the magnetic conductive sheet is 150, then a corresponding relationship of the frequency (Freq), impedance (Zs), inductance and quality factor Q of the communication antenna 11 is showed as Table 1:

TABLE 1

| Freq (MHz) | Zs | Inductance (uH) | Q |
|---|---|---|---|
| 0.2 | 0.63 + j16.1 | 12.8 | 25.6 |
| 1.2 | 2.1 + j94 | 12.5 | 44.8 |
| 2.2 | 3.3 + j171.7 | 12.4 | 52 |
| 3.2 | 4.6 + j250 | 12.4 | 54.3 |
| 4.2 | 6 + j329.3 | 12.5 | 54.9 |
| 5.2 | 7.5 + j410.2 | 12.6 | 54.7 |
| 6.2 | 9.1 + j493.1 | 12.7 | 54.2 |
| 7.2 | 10.9 + j578.6 | 12.8 | 53.1 |
| 8.2 | 12.9 + j667.1 | 13 | 51.8 |
| 9.2 | 15.2 + j759.4 | 13.1 | 50 |
| 10.2 | 17.7 + j856 | 13.4 | 48.4 |
| 11.2 | 20.6 + j957.7 | 13.6 | 46.5 |
| 12.2 | 23.9 + j1065.5 | 13.9 | 44.6 |
| 13.2 | 27.7 + j1180.4 | 14.2 | 42.6 |
| 14.2 | 32.1 + j1303.6 | 14.6 | 40.6 |
| 15.2 | 37.2 + j1436.5 | 15 | 38.6 |
| 16.2 | 43.3 + j1581 | 15.5 | 36.5 |
| 17.2 | 50.4 + j1739.1 | 16.1 | 34.5 |
| 18.2 | 59 + j1913.6 | 16.7 | 32.4 |
| 19.2 | 69.5 + j2107.6 | 17.5 | 30.3 |

It can be seen from table 1 that, in the low frequency range, the communication antenna 11 can reach the required inductance and the Q value is high.

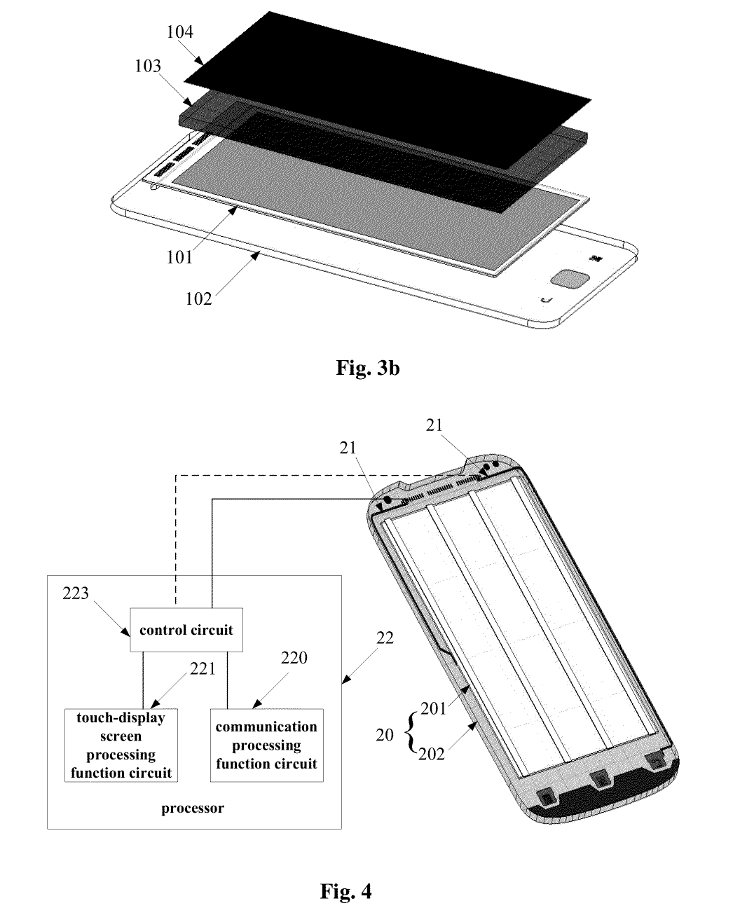

An embodiment of the present invention provides another communication device, which may be a device such as a mobile phone, a GPS device or a Personal Digital Assistant, the schematic diagram of the logic structure of the communication device is showed in FIG. 4, which includes:

a touch-display screen 20, a communication antenna 21, a control circuit 223, a touch-display screen processing function circuit 221 and a communication processing function circuit 220, where an electrode included in the touch-display screen 20 is reused as the communication antenna 21, the communication antenna 21 is connected with the touch-display screen processing function circuit 221 and the communication processing function circuit 220 via the control circuit 223. The control circuit 223 is adapted to control the communication antenna 21 to make it perform a communication function corresponding to the communication antenna 21 during an idle state of performing the electrode function; the communication processing function circuit 220 is adapted to perform a corresponding process on the signal received and/or transmitted by the communication antenna 21 when the communication antenna 21 performs the communication function; and the touch-display screen processing function circuit 221 is adapted to determine whether the user touches the touch-display screen 20 and the touch position according to the change of the signal of the electrode when the communication antenna 21 performs the electrode function.

It can be understood that, the touch-display screen 20 may be a capacitive touch-display screen and so on, in the present embodiment, the touch-display screen 20 includes a display such as an LCD (not shown in FIG. 4), a touch screen body 201 and a cover lens 202 in an order from top to bottom (i.e. a direction that the user looks the touch-display screen 20 from the back surface of the touch-display screen 20), and the touch-display screen 20 may further include electrodes formed by multiple conductive materials, a FPC for connecting the touch-display screen 20 and a processor in the communication device, and metal wires for connecting the electrodes and the FPC. The touch screen body 201 may be arranged inside the display, or may be arranged at places such as the surface of the display; the connection between the communication antenna 21 and the control circuit 223 may be achieved by FPC or may be achieved directly by metal wires, and the touch screen body 201 is provided thereon with both the touch electrode and the metal wires for connecting the FPC, then any one of the electrodes included in the touch screen body 201 of the touch-display screen 20 may be connected (by metal wires of the electrode) to the control circuit 223 to form a monopole antenna when the electrode of the touch-display screen 20 is reused as the communication antenna 21, where the length of the electrode may be determined according to actual operation frequency band.

As shown in FIG. 4, the dashed line indicates a monopole antenna with a certain length connected between the metal wire part of the electrode and the control circuit 223, and the solid line indicates a monopole antenna with another length connected between the metal wire part of the electrode and the control circuit 223, any one of the two ways may be selected, and the metal wire part of the electrode may be located on the touch screen body 201 or the cover lens 202.

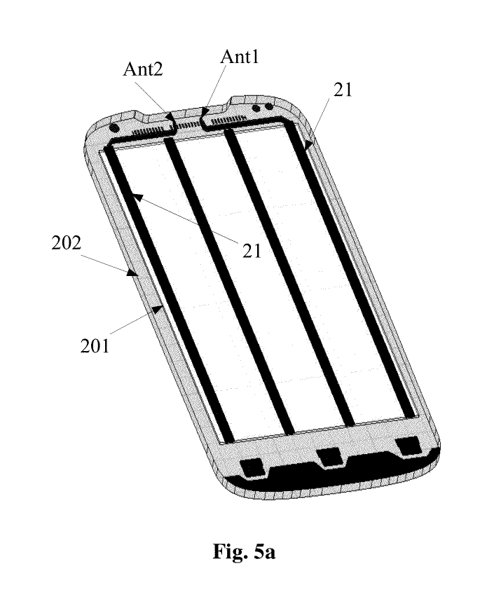

In other embodiments, as shown in FIG. 5a which is a schematic diagram illustrating that the electrode in the touch-display screen 20 is reused as the communication antenna 21, two symmetrical DRIVER electrodes (or two symmetrical SENSOR electrodes) on the touch screen body 201 included in the touch-display screen 20 are connected with the control circuit 223 via interfaces Ant1 and Ant2 respectively, thereby the interfaces Ant1 and Ant2 may form a dipole antenna; as shown in FIG. 5b which is another schematic diagram illustrating that the electrode in the touch-display screen 20 is reused as the communication antenna 21, four symmetrical DRIVER electrodes (or four symmetrical SENSOR electrodes) on the touch screen body 201 included in the touch-display screen are connected with the control circuit 223 via interfaces Ant1 and Ant1_{—}1 and interfaces Ant2 and Ant2_{—}2 respectively, thereby the interfaces Ant1 and Ant1_{—}1 form a dipole antenna, and the interfaces Ant2 and Ant2_{—}2 form another dipole antenna, an dipole antenna array may be formed by setting dimensions of the dipole antennas, and using the dipole antenna array as the communication antenna 21 can obtain higher gain and direction coefficient.

It can be seen that, in the process of implementing the communication antenna of the present embodiment, a monopole antenna formed by a single SENSOR electrode on the touch screen body 201 may be used as the communication antenna 21; or a dipole antenna formed by two symmetrical SENSOR electrodes on the touch screen body 201 may be used as the communication antenna 21; or a dipole antenna array formed by 2N symmetrical SENSOR electrodes on the touch screen body 201 may be used as the communication antenna 21, where N is a positive integer greater than 1.

The communication antenna 21 may be any one of the following antennas: a GPS communication antenna, a wireless charging antenna, an NFC antenna, an RFID antenna, a Bluetooth communication antenna, a Wi-Fi communication antenna, an FM antenna and a TV broadcast antenna, etc, and may be a near field antenna or a far field antenna, the method that the electrode is reused as the communication antenna 21 is generally suitable for the far field antenna.

The control circuit 223 described above is mainly used to coordinate the communication processing function and the touch-display screen processing function. Specifically, the communication antenna 21 may be controlled to perform the communication function corresponding to the communication antenna 21 during the idle state of performing the electrode function (which may be a certain time period or a certain frequency band) by using a time division multiplexing, a frequency division multiplexing or a code division multiplexing, specifically, the control circuit 223 may perform a control to enable or disable the communication function and control the clock of the communication function according to a certain strategy; the communication processing function circuit 220 processes the signal received and/or transmitted by the communication antenna 21 differently as the type of the communication antenna 21 is different, which may include processing the signal, which is received and/or transmitted by communication antenna 21, by using a communication protocol corresponding to the communication antenna 21, and performing functions such as storing and transferring of data, and for example:

If communication antenna 21 is a wireless charging antenna, the control circuit 223 controls the communication antenna 21 to make it perform a wireless charging communication function (including receiving a signal and/or transmitting a signal) during an idle state of performing the electrode function, and the communication processing function circuit 220 charges the communication device by using the signal received by the communication antenna 21 as a charging signal, and charges other devices by using the signal transmitted from the communication antenna 21. Charging the communication device by using the charging signal is achieved mainly by electromagnetic induction, and the control circuit 223 may control the communication function of the wireless charging antenna according to a certain control strategy, for example, the signal receiving function of the wireless charging antenna may be disabled and the signal transmitting function may be reserved when it is detected that a wired charger is plugged in, and in this case the communication device serves as a charging station for charging other devices.

If the communication antenna 21 is an NFC antenna, the control circuit 223 may control the communication antenna to make it perform an NFC communication function during an idle state of performing the electrode function, and the control circuit 223 may also control the communication processing function circuit 220 to make it operate in an active mode or in a passive mode. In the active mode, the communication processing function circuit 220 initiates communications with other devices via the NFC antenna actively, and in the passive mode, the communication processing function circuit 220 detects a signal transmitted from other devices and received by the NFC antenna passively. The communication processing function circuit 220 may also pack a signal to be transmitted by the NFC antenna by using an NFC protocol and deliver the packed signal to the NFC antenna for transmitting, or after the NFC antenna receives a signal, the communication processing function circuit 220 may unpack the received signal by using the NFC protocol and then perform some processes. The NFC protocol may include but not limit to various near field non-contact communication technical protocols such as ISO/IEC18092, ISO14443, MIFARE and Felica.

If the communication antenna 21 is an RFID communication antenna, the control circuit 223 controls the communication antenna to make it perform an RFID communication function during an idle state of performing the electrode function, and may also control the RFID communication antenna to use it as a signal reader and/or a signal tag, where the RFID communication antenna receives a signal from other RFID communication devices when being used as the signal reader, and the RFID communication antenna may transmit a signal to other RFID communication device when being used as the signal tag. The communication processing function circuit 220 may process the signal received and/or transmitted by the RFID communication antenna according to an RFID communication protocol.

It should be noted that, the control circuit 223 and the communication processing function circuit 220 described above may be integrated into a separate chip; or may be integrated into a processor (i.e. a touch screen controller) where the touch-display screen processing function circuit 221 is located; or may be integrated into one or more existing processors 22 (integrated into a processor 22 in FIG. 4) of the communication device, such as integrated into a display controller or a system processor; or some functions are integrated into one or more existing processors of the communication device, and other functions are integrated into a separate and newly added processor. FIG. 4 shows one specific implementation. The considerations that which processors these circuits are integrated into are similar to that of the integration of the communication processing function circuit 120 in other embodiment of the communication device, and the detailed description is omitted herein.

Further, the touch-display screen processing function circuit 221 may include: a displaying function circuit and a touch-control function circuit, and the touch-control function circuit and the displaying function circuit are provided separately, i.e. they are integrated into separate chips respectively, or integrated together, i.e., integrated into a same chip, where the displaying function circuit is adapted to control the displaying of the touch-display screen 20, and the touch-control function circuit is adapted to control the touch screen body 201 of the touch-display screen 20.

It can be seen that, in the communication device of the embodiment of the present invention, if a new communication function is added, the electrode included in the touch-display screen 20 of the communication device may be reused as the communication antenna 21, and the communication function and the electrode function are coordinated by the control circuit 223. In addition, the communication processing function circuit 220 corresponding to the communication antenna 21 and the processor of the communication device are configured and combined flexibly, this takes full advantage of the space of the existing component parts of the communication device and a separate module does not need to be added into the communication device to achieve the communication function, so that the volume of the communication device is not increased when the new communication function is added to the communication device.

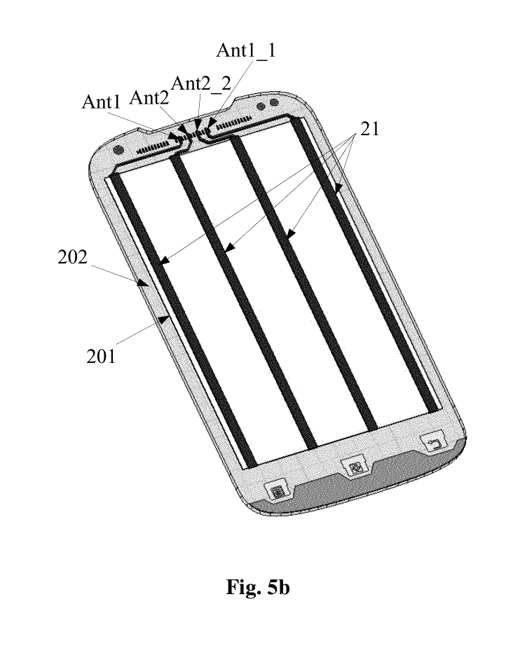

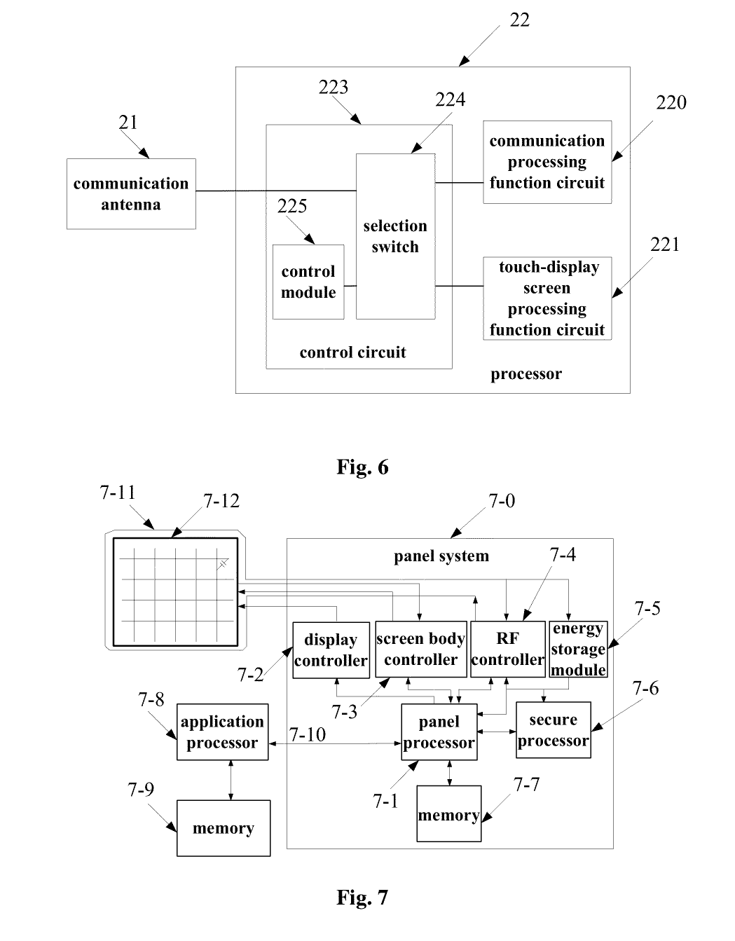

Referring to FIG. 6, in a specific embodiment, the control circuit 223 of the communication device may be implemented by a selection switch 224 and a control module 225, and specifically:

the communication antenna 21 is connected with the touch-display screen processing function circuit 221 or the communication processing function circuit 220 via the selection switch 224, and a selection control terminal of the selection switch 224 is connected to the control module 225. The control module 225 controls the function of the communication antenna 21 according to a certain strategy (such as time division multiplexing, frequency division multiplexing or code division multiplexing), and selects whether the communication antenna 21 is connected to the touch-display screen processing function circuit 221 or connected to the communication processing function circuit 220 by the selection control terminal. For example, the control module 225 controls the communication antenna 21 to make it perform the communication function within a time period or in a certain frequency band by connecting the communication antenna 21 to the communication processing function circuit 220 by the selection control terminal; and the control module 225 controls the communication antenna 21 to make it perform the touch control electrode function within another time period or in another frequency band by connecting the communication antenna 21 to the touch-display screen processing function circuit 221 by the selection control terminal.

The communication device in the embodiment of the present invention will be described hereinafter according to a specific application example, and the communication device is a capacitive touch screen device, which mainly includes a touch-display screen and a panel system 7-0, where the touch-display screen is a capacitive touch screen. An annular coil is arranged at a free position of the back surface of the touch-display screen and serves as the communication antenna 7-11. The touch-display screen also includes a touch panel 7-12 and so on, where the touch panel 7-12 is a combination of the touch screen body and the display in the embodiment described above. In order to achieve single processor management, the communication processing function circuit in the above embodiment may be integrated into a processing system, i.e. the panel system 7-0. Specifically,

The panel system 7-0 mainly includes a touch screen processing circuit and is also integrated with a radio frequency communication processing function circuit, which mainly includes a display controller (Display Operator) 7-2, a touch screen body controller (Touch Operator) 7-3 and functions related to radio frequency (RF), such as a RF controller (RF operator) 7-4, an RF energy storage (Powered for RF) module 7-5 and a secure processor (secure Processor) 7-6. The panel system 7-0 also includes a panel processor (panel operator) 7-1 for coordinating operations of each part.

The panel processor 7-1 is mainly adapted to directly transfer commands or data via an interface 7-10 between the panel processor 7-1 and an application processor (AP processor) 7-8, control and coordinate function modules of the panel system 7-0, and process data of the function modules.

The display controller 7-2 is mainly adapted to perform a driving control on an Liquid Crystal Display of the touch panel 7-12, and may control the touch screen body under the control of the panel processor 7-1.

The touch screen body controller 7-3 is mainly adapted to judge whether there is a touch by detecting the change of the capacitance of the touch screen body of the touch panel 7-12. In order to decrease power consumption, the touch may be detected according to the time set by the panel processor 7-1, the detected data is delivered to the panel processor 7-1 for processing if the touch is detected. The panel processor 7-1 may obtain coordinates of the touch by performing a calculation, and upload information of the coordinates of the touch to the application processor 7-8 via the interface 7-10.

The RF controller 7-4 is connected with the communication antenna 7-11 on the touch-display screen, and mainly operates in an active mode or in a passive mode. In the active mode, the RF controller 7-4 actively initiate a communication with other RF device by the communication antenna 7-11; and in the passive mode, the RF controller 7-4 passively detects a signal transmitted from other RF device. The signal received or transmitted by communication antenna 7-11 is processed by the panel processor 7-1 according to a corresponding communication protocol, specifically, service processes such as signal identification, writing, calculation, reading, distance control and data encoding/decoding may be implemented, and the communication of the communication antenna 7-11 is mainly a communication such as the RFID communication or the NFC communication.

The RF energy storage module 7-5 is mainly adapted to charge the panel system 7-0 for energy storage by modulating the signal of a host system of the communication device if the RF controller 7-4 is in the passive mode or if the panel system 7-0 is in a power-down mode or in a power-save mode, so that the operating current consumption of each RF circuit (such as the RF controller 7-4, the secure processor 7-6 and the panel processor 7-1) of the panel system 7-0 is satisfied.

The secure processor 7-6 is mainly adapted to ensure the security of the transaction between the communication antenna 7-11 and other RF device, and encrypt the transaction information, which may specifically include generating a user key, a secure key algorithm and so on by a random generator.

A memory 7-7 is mainly adapted to store programs, cache data, preserve keys and so on, so as to meet requirements on program running and data calculation of the panel processor 7-1 in the panel system 7-0, the memory 7-7 may be one or more physical mediums such as SRAM, ROM, EEPROM and flash.

The application processor 7-8 is mainly adapted to exchange commands and data with the panel system 7-0 via the communication interface 7-10.

A memory 7-9 of the application processor is mainly adapted to store programs and data so as to meet the requirements of the application processor 7-8.

It should be noted that, in the process of RF communication of the communication device in the present embodiment, and in the active mode, the display controller 7-2 and the RF controller 7-4 operate under the control of the panel processor 7-1, the touch screen body controller 7-3 detects the touch on the touch screen body according to a time set by the panel processor 7-1, the panel processor 7-1 performs the processing function of the touch-display screen if the touch is detected, and the RF controller 7-4 actively triggers the communication antenna 7-11 to make it transmit a signal to other device.

In the passive mode, the display controller 7-2 transmits a signal, which satisfies the displaying of the touch screen body, under the control of the panel processor 7-1, the touch screen body controller 7-3 detects the touch on the touch screen body according to a set time, and the panel processor 7-1 performs the processing function of the touch-display screen if the touch is detected. The RF controller 7-4 also detects the touch on the touch screen body according to a set time, and the panel processor 7-1 performs processes on the RF signal, such as service processes of identification, writing, calculation, reading, distance control and data encrypting/decrypting, if the touch is detected.

The communication devices according to the embodiments of the present invention are described in detail above, and the principle and embodiments of the present invention are clarified by specific examples herein, the above description of the embodiments is only to facilitate understanding of the method and core idea of the present invention; and meanwhile, for those skilled in the art, changes may be made for both specific embodiments and application ranges according to the idea of the present invention. Therefore, the present specification should not be understood as limiting the scope of the present invention.

1. A communication device, comprising: a touch-display screen, a communication antenna and a communication processing function circuit, wherein
the communication antenna is arranged on a surface of the touch-display screen or is embedded inside the touch-display screen; the communication antenna is connected with the communication processing function circuit; and
the communication processing function circuit is adapted to control the communication antenna to make it perform a communication function, and perform a corresponding process on a signal received and/or transmitted by the communication antenna.

2. The communication device according to claim 1, wherein the communication antenna is a near field antenna or a far field antenna, the touch-display screen comprises a touch screen body, a cover lens and a display, the touch-display screen is connected with the communication processing function circuit via a Flexible Printed Circuit FPC or a metal wire;
the communication antenna is arranged on the surface of the touch-display screen or is embedded inside the touch-display screen, which comprises:
the communication antenna is arranged in a free area of an invisible region of any one of the following structures: the cover lens, periphery of the touch screen body, the display and the FPC; or
the communication antenna is arranged in an area with no interference-avoiding requirement of any one of the following structures: the cover lens, the touch screen body, the display and the FPC; or
the communication antenna is arranged inside the touch screen body or the display.

3. The communication device according to claim 2, wherein
if the communication antenna is a near field antenna, the communication antenna comprises a single-circle annular coil or a multi-circle annular coil, the annular coil is arranged on one surface of any one of the following structures: the touch screen body, the cover lens, the display and the FPC; or the annular coil is arranged on two surfaces of any one of the following structures: the touch screen body, the cover lens, the display and the FPC; and the annular coil is rectangular, elliptical or racetrack-shaped;
if the communication antenna is a far field antenna, the communication antenna comprises any one of the following antennas: a folded monopole antenna, a circular or elliptical polarized antenna, a monopole antenna and a dipole antenna.

4. The communication device according to claim 2, wherein
the touch screen body is arranged inside the display or is arranged on a surface of the display.

5. The communication device according to claim 2, wherein the touch-display screen has the following stack order from top to bottom: the display, the touch screen body and the cover lens,
the touch-display screen of the communication device further comprises a magnetic conductive sheet, the magnetic conductive sheet is affixed to the communication antenna, and is located between the touch screen body and the display and located in periphery of the display; or
the magnetic conductive sheet is affixed to the display.

6. The communication device according to claim 1, wherein
the communication processing function circuit is integrated into a separate chip which is newly added into the communication device; or is integrated into a touch screen controller of the communication device; or is integrated into a display controller of the communication device; or is integrated into a system processor of the communication device; or is integrated into a plurality of processors of the communication device.

7. The communication device according to claim 2, wherein
the communication processing function circuit is integrated into a separate chip which is newly added into the communication device; or is integrated into a touch screen controller of the communication device; or is integrated into a display controller of the communication device; or is integrated into a system processor of the communication device; or is integrated into a plurality of processors of the communication device.

8. The communication device according to claim 1, wherein the communication antenna is connected to a ground terminal via a switch,
the communication processing function circuit is connected with a control terminal of the switch, the communication processing function circuit is further adapted to control the switch to make it closed if a communication function corresponding to the communication antenna is in an inactive state.

9. The communication device according to claim 2, wherein the communication antenna is connected to a ground terminal via a switch;
the communication processing function circuit is connected with a control terminal of the switch, the communication processing function circuit is further adapted to control the switch to make it closed if a communication function corresponding to the communication antenna is in an inactive state.

10. The communication device according to claim 1, wherein if the communication antenna is a wireless charging antenna, the communication processing function circuit is adapted to control the wireless charging antenna to make it transmit a signal and/or receive a signal, and charge the communication device by using the signal received by the wireless charging antenna as a charging signal;
if the communication antenna is a Near Field Communication NFC antenna, the communication processing function circuit is adapted to control the communication antenna to make it perform an NFC communication function, and the communication processing function circuit operates in an active mode or in a passive mode; and
if the communication antenna is a Radio Frequency Identification RFID communication antenna, the communication processing function circuit is adapted to control the communication antenna to make it perform an RFID communication function, and control the RFID communication antenna to use it as a signal reader and/or a signal tag.

11. The communication device according to claim 1, wherein the touch-display screen is a capacitive touch-display screen.

12. A communication device, comprising: a touch-display screen, a communication antenna, a control circuit, a touch-display screen processing function circuit and a communication processing function circuit,
an electrode included in the touch-display screen is reused as the communication antenna, and the communication antenna is connected with the touch-display screen processing function circuit and the communication processing function circuit via the control circuit,
wherein the control circuit is adapted to control the communication antenna to make it perform a communication function corresponding to the communication antenna during an idle state of performing an electrode function, and the communication processing function circuit is adapted to perform a corresponding process on a signal received and/or transmitted by the communication antenna when the communication antenna performs the communication function.

13. The communication device according to claim 12, wherein if the communication antenna is a near field antenna or a far field antenna, the touch-display screen comprises: a touch screen body, a cover lens and a display, the touch-display screen is connected with the control circuit via a Flexible Printed Circuit FPC or a metal wire,
the electrode included in the touch-display screen is reused as the communication antenna, which comprises: a monopole antenna formed by a single SENSOR electrode on the touch screen body is used as the communication antenna; or
a dipole antenna formed by two symmetrical SENSOR electrodes on the touch screen body is used as the communication antenna; or
a dipole antenna array formed by 2N symmetrical SENSOR electrodes on the touch screen body is used as the communication antenna, wherein N is a positive integer greater than 1.

14. The communication device according to claim 13, wherein
the touch screen body is arranged inside the display, or is arranged on a surface of the display;
the touch-display screen processing function circuit comprises a displaying function circuit and a touch-control function circuit, and the touch-control function circuit and the displaying function circuit are provided separately or are integrated together.

15. The communication according to claim 12, wherein the control circuit comprises a selection switch and a control module,
the communication antenna is connected with the touch-display screen processing function circuit or the communication processing function circuit via the selection switch, a selection control terminal of the selection switch is connected to the control module, and
the control module is adapted to select whether the communication antenna is connected to the touch-display screen processing function circuit or connected to the communication processing function circuit by the selection control terminal.

16. The communication device according to claim 12, wherein
the control circuit and the communication processing function circuit are integrated into a separate chip which is newly added into the communication device; or are integrated into a processor of the communication device where the touch-display screen processing function circuit is located; or are integrated into a display controller of the communication device; or are integrated into a system processor of the communication device; or are integrated into a plurality of processors of the communication device.

17. The communication device according to claim 13, wherein
the control circuit and the communication processing function circuit are integrated into a separate chip which is newly added into the communication device; or are integrated into a processor of the communication device where the touch-display screen processing function circuit is located; or are integrated into a display controller of the communication device; or are integrated into a system processor of the communication device; or are integrated into a plurality of processors of the communication device.

18. The communication device according to claim 12, wherein
if the communication antenna is a wireless charging antenna, the control circuit is adapted to, in a time division multiplexing manner, a frequency division multiplexing manner or a code division multiplexing manner, control the communication antenna to make it perform a wireless charging communication function during the idle state, the communication processing function circuit is adapted to charge the communication device by using a signal received by the wireless charging antenna as a charging signal; the wireless charging communication function comprises transmitting a signal and/or receiving a signal;
if the communication antenna is a Near Field Communication NFC antenna, the control circuit is adapted to, in a time division multiplexing manner, a frequency division multiplexing manner or a code division multiplexing manner, control the communication antenna to make it perform an NFC communication function during the idle state, and the control circuit is further adapted to control the communication processing function circuit to make it operates in an active mode or in a passive mode; and
if the communication antenna is a Radio Frequency Identification RFID communication antenna, the control circuit is adapted to, in a time division multiplexing manner, a frequency division multiplexing manner or a code division multiplexing manner, control the communication antenna to make it perform an RFID communication function during the idle state, and control the RFID communication antenna to use it as a signal reader and/or a signal tag.

19. The communication device according to claim 13, wherein
if the communication antenna is a wireless charging antenna, the control circuit is adapted to, in a time division multiplexing manner, a frequency division multiplexing manner or a code division multiplexing manner, control the communication antenna to make it perform a wireless charging communication function during the idle state, the communication processing function circuit is adapted to charge the communication device by using a signal received by the wireless charging antenna as a charging signal; the wireless charging communication function comprises transmitting a signal and/or receiving a signal;
if the communication antenna is a Near Field Communication NFC antenna, the control circuit is adapted to, in a time division multiplexing manner, a frequency division multiplexing manner or a code division multiplexing manner, control the communication antenna to make it perform an NFC communication function during the idle state, and the control circuit is further adapted to control the communication processing function circuit to make it operates in an active mode or in a passive mode; and
if the communication antenna is a Radio Frequency Identification RFID communication antenna, the control circuit is adapted to, in a time division multiplexing manner, a frequency division multiplexing manner or a code division multiplexing manner, control the communication antenna to make it perform an RFID communication function during the idle state, and control the RFID communication antenna to use it as a signal reader and/or a signal tag.

20. The communication device according to claim 12, wherein the touch-display screen is a capacitive touch-display screen.
